(19) United States
(12) Patent Application Publication
(10) Pub. No.: US 2023/0036438 A1
(43) Pub. Date: Feb. 2, 2023

(54) SYSTEMS AND METHODS FOR SYSTEM HEALTH-BASED MEETING DEVICE CONTEXT SELECTION

(71) Applicant: Dell Products L.P., Round Rock, TX (US)

(72) Inventors: Balasingh Ponraj SAMUEL, Round Rock, TX (US); Jacob MINK, Austin, TX (US)

(73) Assignee: Dell Products L.P., Round Rock, TX (US)

(21) Appl. No.: 17/391,552

(22) Filed: Aug. 2, 2021

(51) Int. Cl. H04L 29/06; H04L 12/24

(52) U.S. Cl. CPC H04L 65/80; H04L 41/0668; H04L 65/1083

(57) ABSTRACT

An information handling system may include a processor and instructions embodied in non-transitory computer-readable media coupled to the processor, the instructions configured to, when read and executed by the processor, in response to commencement of a meeting using a conferencing platform software of the information handling system, monitor one or more parameters indicative of a health of the information handling system, determine the health of the information handling system based on such one or more parameters, and in response to determining the information handling system is unhealthy, wirelessly communicate an alert to a second information handling system indicating that the information handling system is unhealthy.

### TECHNICAL FIELD

The present disclosure relates in general to information handling systems, and more particularly, systems and methods for system health-device context selection for a device used to conduct a meeting.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Videoconferencing software platforms have seen increased use since their introduction, with use increasing significantly due to the COVID-19 pandemic. Such videoconferencing platforms may be used for remote work, remote communication and collaboration, distance education, and online social relations.

Because videoconferencing platforms consume significant resources of an information handling system (e.g., video, audio, network, etc.), processing, memory, and/or network resources of an information handling system may not always be capable of handling a meeting. Such may be particularly true when a teleconference participant needs to execute one or more other programs on an information handling system other than the video conferencing platform.

Such problems may lead to system crashes, poor meeting quality, poor system performance, and/or interruption in productivity. Accordingly, methods and systems to overcome such disadvantages are desired.

### SUMMARY

In accordance with the teachings of the present disclosure, the disadvantages and problems associated with teleconferences platforms may be reduced or eliminated.

In accordance with embodiments of the present disclosure, an information handling system may include a processor and instructions embodied in non-transitory computer-readable media coupled to the processor, the instructions configured to, when read and executed by the processor, in response to commencement of a meeting using a conferencing platform software of the information handling system, monitor one or more parameters indicative of a health of the information handling system, determine the health of the information handling system based on such one or more parameters, and in response to determining the information handling system is unhealthy, wirelessly communicate an alert to a second information handling system indicating that the information handling system is unhealthy.

In accordance with these and other embodiments of the present disclosure, a method may include, in response to commencement of a meeting using a conferencing platform software on an information handling system, monitoring one or more parameters indicative of a health of the information handling system, determining the health of the information handling system based on such one or more parameters, and in response to determining the information handling system is unhealthy, wirelessly communicating an alert to a second information handling system indicating that the information handling system is unhealthy.

In accordance with these and other embodiments of the present disclosure, a method may include, in response to receipt of an indication from a first information handling system, at a second information handling system, of commencement of a meeting using a conferencing platform software on the information handling system, monitoring for an alert from the first information handling system indicating that the first information handling system is unhealthy, and responsive to the alert, switching context of the meeting from the first information handling system to the second information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system including a primary information handling system and a secondary information handling system, in accordance with certain embodiments of the present disclosure; and

FIG. 2 illustrates a flow chart of an example method for system health-based meeting device-context selection, in accordance with certain embodiments of the present disclosure.

### DETAILED DESCRIPTION

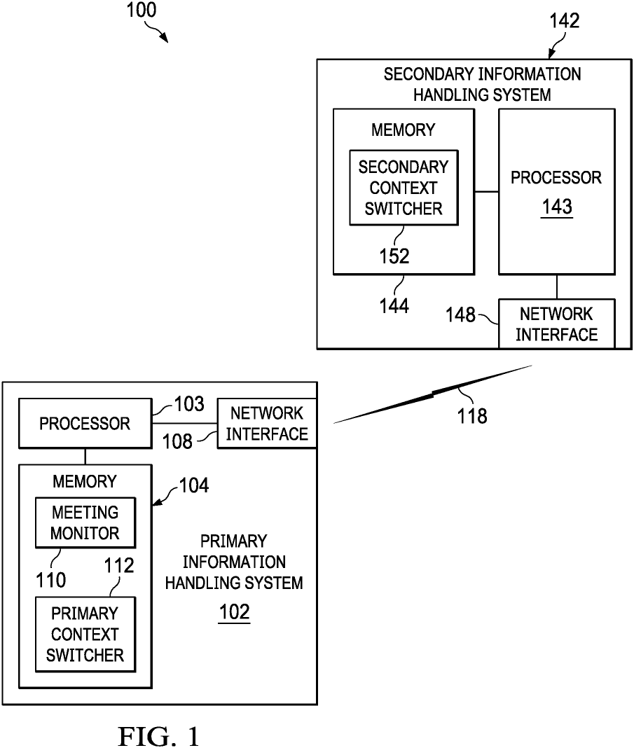

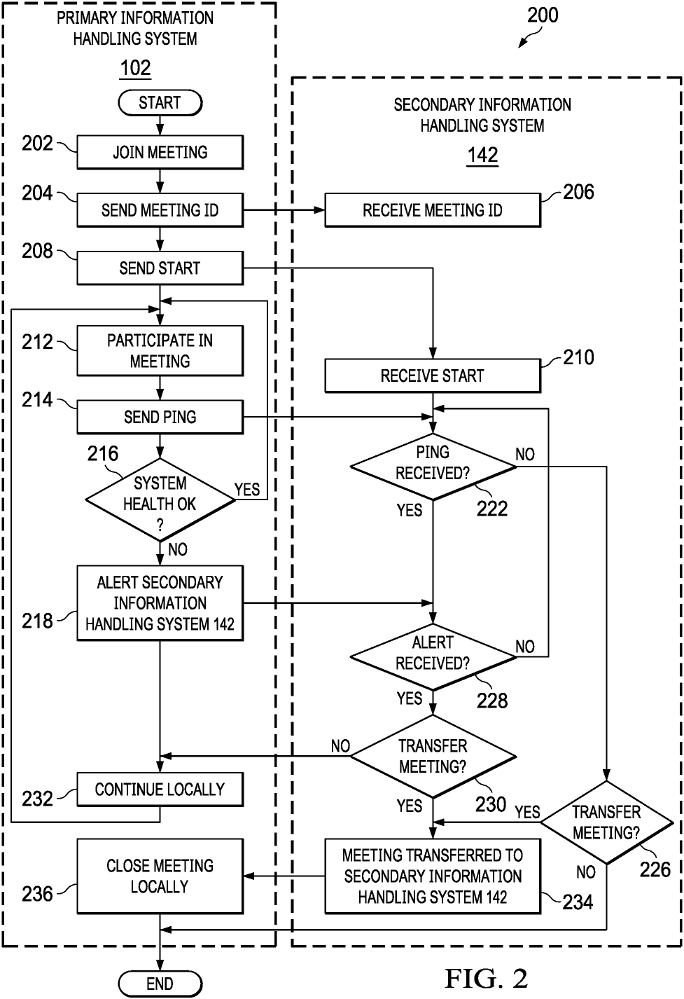

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, busses, memories, I/O devices and/or interfaces, storage resources, network interfaces, motherboards, and/or any other components and/or elements of an information handling system.

The terms “wireless transmissions” and “wireless communication” may be used to refer to all types of electromagnetic communications which do not require a wire, cable, or other types of conduits. Examples of wireless transmissions which may be used include, but are not limited to, short-range wireless communication technologies (e.g., proximity card, Radio-Frequency Identification (RFID), Near Field Communication (NFC), BLUETOOTH, ISO 14443, ISO 15693, or other suitable standard), IEEE 802.11ad (Wireless Gigabit or “WiGig”), personal area networks (PAN) (e.g., BLUETOOTH), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

The term “wire-line transmissions” may be used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wire-line transmissions may be conducted in accordance with teachings of the present disclosure over electrical power lines, electrical power distribution systems, building electrical wiring, conventional telephone lines, Ethernet cabling (10baseT, 100baseT, etc.), coaxial cables, T-1 lines, T-3 lines, ISDN lines, ADSL, etc.

FIG. 1 illustrates a block diagram of an example system 100 including a primary information handling system 102 and a secondary information handling system 142, in accordance with certain embodiments of the present disclosure.

In some embodiments, primary information handling system 102 may be a personal computer. In particular embodiments, primary information handling system 102 may be a portable information handling system (e.g., a laptop, notebook, tablet, handheld, smart phone, personal digital assistant, etc.). As depicted in FIG. 1, primary information handling system 102 may include a processor 103, a memory 104 communicatively coupled to processor 103, and a network interface 108 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of primary information handling system 102.

Memory 104 may include any system, device, or apparatus configured to retain data (including program instructions) for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to primary information handling system 102 is turned off.

As shown in FIG. 1, memory 104 may have stored thereon a meeting monitor 110. As described in greater detail elsewhere in this disclosure, meeting monitor 110 may comprise any application, service, and/or other program of instructions stored on memory 104 and configured to, when read and executed by processor 103, monitor system performance of and environmental factors associated with primary information handling system 102 and based thereon, provide a score of system health for primary information handling system 102. In some embodiments, meeting monitor 110 may be a component of an operating system. In other embodiments, meeting monitor 110 may comprise a component of videoconferencing platform software. In yet other embodiments, meeting monitor 110 may comprise a separate application capable of executing on an operating system of primary information handling system 102.

As also shown in FIG. 1, memory 104 may have stored thereon a primary context switcher 112. As described in greater detail elsewhere in this disclosure, primary context switcher 112 may comprise any application, service, and/or other program of instructions stored on memory 104 and configured to, when read and executed by processor 103, couple (e.g., via network interface 108) to a companion device (e.g., secondary information handling system 142) in order to proactively and securely switch a meeting context from primary information handling system 102 to secondary information handling system 142.

Network interface 108 may comprise any suitable system, apparatus, or device operable to serve as an interface between primary information handling system 102 and another information handling system and/or a network. Network interface 108 may enable primary information handling system 102 to communicate using any suitable transmission protocol and/or standard. In some embodiments, network interface 108 may be configured to communicate with network interface 148 of secondary information handling system 142 via wireless transmissions 118. In these and other embodiments, network interface 108 may comprise a network interface card, or “NIC.”

In addition to processor 103, memory 104, and network interface 108, primary information handling system 102 may include one or more other information handling resources. For example, primary information handling system 102 may include input/output devices such as a keyboard, pointing device (mouse and/or trackpad), video display monitor, microphone, and/or one or more speakers. As another example, primary information handling system 102 may include videoconferencing platform software embodied in memory 104 or other non-transitory computer-readable media integral to or otherwise accessible by information handling system 102.

In some embodiments, secondary information handling system 142 may be a personal computer. In particular embodiments, secondary information handling system 142 may be a portable information handling system (e.g., a laptop, notebook, tablet, handheld, smart phone, personal digital assistant, etc.). In some embodiments, primary information handling system 102 may include a device more traditionally referred to as a “computer,” such as a desktop/tower computer or a laptop/notebook computer, while secondary information handling system 142 may include a device more traditionally referred to as a “mobile device,” such as a tablet or smartphone.

As depicted in FIG. 1, secondary information handling system 142 may include a processor 143, a memory 144 communicatively coupled to processor 143, and a network interface 148 communicatively coupled to processor 143.

Processor 143 may include any system, device, or apparatus configured to interpret and/or execute program instructions and/or process data, and may include, without limitation, a microprocessor, microcontroller, DSP, ASIC, or any other digital or analog circuitry configured to interpret and/or execute program instructions and/or process data. In some embodiments, processor 143 may interpret and/or execute program instructions and/or process data stored in memory 144 and/or another component of secondary information handling system 142.

Memory 144 may include any system, device, or apparatus configured to retain data (including program instructions) for a period of time (e.g., computer-readable media). Memory 144 may include RAM, EEPROM, a PCMCIA card, flash memory, magnetic storage, opto-magnetic storage, or any suitable selection and/or array of volatile or non-volatile memory that retains data after power to secondary information handling system 142 is turned off.

As shown in FIG. 1, memory 144 may have stored thereon a secondary context switcher 152. As described in greater detail elsewhere in this disclosure, secondary context switcher 152 may comprise any application, service, and/or other program of instructions stored on memory 144 and configured to, when read and executed by processor 143, receive notifications (e.g., via network interface 148) from primary context switcher 112 and may, in response to a notification to switch a meeting context from primary information handling system 102 to secondary information handling system 142, launch a meeting in an appropriate videoconferencing application of secondary information handling system 142.

Network interface 148 may comprise any suitable system, apparatus, or device operable to serve as an interface between secondary information handling system 142 and another information handling system and/or a network. Network interface 148 may enable primary information handling system 142 to communicate using any suitable transmission protocol and/or standard. In some embodiments, network interface 148 may be configured to communicate with network interface 108 of primary information handling system 102 via wireless transmissions 118. In these and other embodiments, network interface 148 may comprise a network interface card, or “NIC.”

In addition to processor 143, memory 144, and network interface 148, primary information handling system 142 may include one or more other information handling resources. For example, primary information handling system 142 may include input/output devices such as a keyboard, pointing device (mouse and/or trackpad), video display monitor, microphone, and/or one or more speakers. As another example, secondary information handling system 142 may include videoconferencing platform software embodied in memory 144 or other non-transitory computer-readable media integral to or otherwise accessible by information handling system 142.

In some embodiments, wireless transmissions 118 between network interface 108 and network interface 148 may comprise near-field communication, such as BLUETOOTH. In these and other embodiments, wireless transmissions 118 between network interface 108 and network interface 148 may comprise Wireless Fidelity (“Wi-Fi”) communications, in which case both of network interface 108 and network interface 148 may be coupled to the same Wi-Fi network. In these and other embodiments, wireless transmissions 118 between network interface 108 and network interface 148 may comprise text (e.g., Short Message Service) communications, in which case both of network interface 108 and network interface 148 may be coupled to the Internet or a data network supporting such text communication.

In operation, a user may install meeting monitor 110 and primary context switcher 112 on primary information handling system 102 and may install secondary context switcher 152 on secondary information handling system 142. In doing so, the user may select near-field (e.g., BLUETOOTH) pairing, Wi-Fi pairing, or none via one or both of primary context switcher 112 and secondary context switcher 152. Secondary information handling system 142 may be securely authorized to primary information handling system 102 in any suitable manner.

Further, the user may specify a threshold health score for meeting context switching or may choose a default threshold health score. In addition, a user may selectively enable or disable an emergency threshold health score for meeting context switching.

In some embodiments, the user may not install secondary context switcher 152 on secondary information handling system 102, in which case any context switching may be text message-based, as described in greater detail below.

FIG. 2 illustrates a flow chart of an example method 200 for system health-based meeting device-context selection, in accordance with certain embodiments of the present disclosure. According to one embodiment, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, primary information handling system 102 may join a meeting via a videoconferencing platform application. At step 204, primary context switcher 112 may communicate a meeting identifier for such meeting to secondary context switcher 152 via wireless transmissions 118. At step 206, secondary context switcher 152 may receive the meeting identifier.

At step 208, primary context switcher 112 may communicate a message, via wireless transmissions 118, to secondary context switcher 152 indicating that the meeting has started. At step 210, secondary context switcher 152 may receive the message that the meeting has started.

At step 212, the user may participate in the meeting on primary information handling system 102. At step 214, primary context switcher 112 may send, via wireless transmissions 118, a “ping” or heartbeat message to secondary context switcher 152 in order to indicate that the meeting remains operable on primary information handling system 102.

At step 216, meeting monitor 110 may monitor one or more parameters indicative of a health of primary information handling system 102, determine a health score based on such one or more parameters, and compare such health score to a user-configurable threshold health score and/or emergency threshold health score to determine if primary information handling system 102 is healthy. Such one or more parameters may include a number of network notifications received at primary information handling system 102, usage of memory 104, usage of processor 103, frequency of system interrupts at processor 103, a temperature associated with primary information handling system 102, a speed of an air mover (e.g., fan or blower), a state of charge of a battery of primary information handling system 102, and/or a wireless signal strength (or other indicator of quality of network connection) associated with primary information handling system 102. If primary information handling system 102 is healthy, method 200 may proceed again to step 212. Otherwise, if primary information handling system 102 is unhealthy, method 200 may proceed to step 218.

At step 218, primary context switcher 112 may communicate an alert (e.g., via wireless transmissions 118) to secondary context switcher 152 that primary information handling system 102 is unhealthy.

At step 222, in response to receipt (e.g., at step 210) of the message that the meeting has started, secondary context switcher 152 may monitor for the ping message communicated from primary context switcher 112. If the ping message is received within a timeout period, method 200 may proceed to step 228. Otherwise, if the ping message is not received within the timeout period (e.g., thus indicating that primary information handling system 102 has frozen or experienced another failure), method 200 may proceed to step 226.

At step 226, secondary context switcher 152 may communicate to a user at secondary information handling system 142 (e.g., via a user interface of secondary information handling system 142) whether the user desires to transfer the meeting to secondary information handling system 142. If the user indicates a desire to transfer the meeting to secondary information handling system 142, method 200 may proceed to step 234. Otherwise, method 200 may end.

At step 228, in response to the ping message being received by secondary context switcher 152, secondary context switcher 152 may determine if an alert has been received from primary context switcher 112 indicating that primary information handling system 102 is unhealthy. If an alert has been received, method 200 may proceed to step 230. Otherwise, method 200 may proceed again to step 222.

At step 230, secondary context switcher 152 may communicate to a user at secondary information handling system 142 (e.g., via a user interface of secondary information handling system 142) whether the user desires to transfer the meeting to secondary information handling system 142. If the user indicates a desire to transfer the meeting to secondary information handling system 142, method 200 may proceed to step 234. Otherwise, method 200 may proceed to step 232.

At step 232, in response to a user desire to not transfer the meeting to secondary information handling system 142, the meeting may continue locally on primary information handling system 102, and method 200 may proceed again to step 212.

At step 234, in response to a user desire to transfer the meeting to secondary information handling system 142, secondary context switcher 152 may cause the meeting to be launched on videoconferencing platform software at secondary information handling system 142.

At step 236, in response to the meeting being transferred to secondary information handling system 142, primary context switcher 112 may cause the meeting to close locally on primary information handling system 102. After completion of step 236, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using system 100 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An information handling system comprising:
a central processing unit (CPU); and
instructions embodied in non-transitory computer-readable media coupled to the CPU, the instructions configured to, when read and executed by the CPU, in response to commencement of a meeting using a conferencing platform software of the information handling system:
monitor one or more parameters indicative of a health of the information handling system;
determine the health of the information handling system based on the one or more parameters; and
in response to determining the information handling system is unhealthy, wirelessly communicate an alert to a second information handling system indicating that the information handling system is unhealthy.

2. The information handling system of claim 1, wherein the alert causes the second information handling system to switch context of the meeting from the information handling system to the second information handling system.

3. The information handling system of claim 1, wherein the alert causes the second information handling system to communicate to a user of the second information handling system a prompt to switch context of the meeting from the information handling system to the second information handling system.

4. The information handling system of claim 1, wherein the one or more parameters include one or more of a number of network notifications received at the information handling system, usage of a memory of the information handling system, usage of a processor of the information handling system, frequency of system interrupts at the processor, a temperature associated with the information handling system, a speed of an air mover of the information handling system, a state of charge of a battery of the information handling system, and an indicator of a quality of a network connection associated with the information handling system.

5. The information handling system of claim 1, wherein the instructions are further configured to communicate a heartbeat message from the information handling system to the second information handling system.

6. The information handling system of claim 5, wherein failure to communicate the heartbeat message causes the second information handling system to switch context of the meeting from the information handling system to the second information handling system.

7. The information handling system of claim 5, wherein failure to communicate the heartbeat message causes the second information handling system to communicate to a user of the second information handling system a prompt to switch context of the meeting from the information handling system to the second information handling system.

8. A method comprising, in response to commencement of a meeting using a conferencing platform software on an information handling system:
monitoring one or more parameters indicative of a health of the information handling system;
determining the health of the information handling system based on the one or more parameters; and
in response to determining the information handling system is unhealthy, wirelessly communicating an alert to a second information handling system indicating that the information handling system is unhealthy.

9. The method of claim 8, wherein the alert causes the second information handling system to switch context of the meeting from the information handling system to the second information handling system.

10. The method of claim 8, wherein the alert causes the second information handling system to communicate to a user of the second information handling system a prompt to switch context of the meeting from the information handling system to the second information handling system.

11. The method of claim 8, wherein the one or more parameters include one or more of a number of network notifications received at the information handling system, usage of a memory of the information handling system, usage of a processor of the information handling system, frequency of system interrupts at the processor, a temperature associated with the information handling system, a speed of an air mover of the information handling system, a state of charge of a battery of the information handling system, and an indicator of a quality of a network connection associated with the information handling system.

12. The method of claim 8, wherein the instructions are further configured to communicate a heartbeat message from the information handling system to the second information handling system.

13. The method of claim 12, wherein failure to communicate the heartbeat message causes the second information handling system to switch context of the meeting from the information handling system to the second information handling system.

14. The method of claim 12, wherein failure to communicate the heartbeat message causes the second information handling system to communicate to a user of the second information handling system a prompt to switch context of the meeting from the information handling system to the second information handling system.

15. A method comprising, in response to receipt of an indication from a first information handling system, at a second information handling system, of commencement of a meeting using a conferencing platform software on the information handling system:
monitoring for an alert from the first information handling system indicating that the first information handling system is unhealthy; and
responsive to the alert, switching context of the meeting from the first information handling system to the second information handling system.

16. The method of claim 15, further comprising:
responsive to the alert, communicating to a user of the second information handling system a prompt to switch context of the meeting from the first information handling system to the second information handling system; and
responsive to a user response to the prompt, switching context of the meeting from the first information handling system to the second information handling system.

17. The method of claim 15, further comprising:
monitoring for a heartbeat message from the first information handling system; and
responsive to a failure to receive the heartbeat message, switching context of the meeting from the first information handling system to the second information handling system.

18. The method of claim 17, further comprising:
responsive to the failure to receive the heartbeat message, communicating to a user of the second information handling system a prompt to switch context of the meeting from the first information handling system to the second information handling system; and
responsive to a user response to the prompt, switching context of the meeting from the first information handling system to the second information handling system.
